(19) United States
(12) Patent Application Publication
(10) Pub. No.: US 2008/0160230 A1
(43) Pub. Date: Jul. 3, 2008

(54) INK JET RECORDING MEDIUM AND METHOD FOR MAKING THE SAME

(75) Inventor: Masamichi Kobayashi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/957,719

(22) Filed: Dec. 17, 2007

(30) Foreign Application Priority Data
Dec. 27, 2006 (JP) 2006-352715

(51) Int. Cl. B41M 5/00; B05D 1/36

(52) U.S. Cl. 428/32.25; 427/203

(57) ABSTRACT

This invention provides an ink jet recording medium comprising a support and at least two layers on one side of the support, wherein the uppermost layer placed farthest from the support comprises a porous colloidal silica and a binder, at least one of the layer(s) that is not the uppermost layer comprises inorganic fine particles having an average primary particle diameter of less than 20 nm and a binder, the content of the inorganic fine particles is 10 g/m² or more, the ratio (A/B) by mass between the inorganic fine particles (A) and the binder (B) is from 3 to 15, and at least the uppermost layer and/or a layer other than the uppermost layer comprises a sulfoxide compound and/or a thioether compound.

### CROSS-REFERENCE TO RELATED APPLICATION

This application claims priority under 35 USC 119 from Japanese Patent Application No. 2006-352715, the disclosure of which is incorporated by reference herein.

### BACKGROUND OF THE INVENTION

1. Field of the Invention

The present invention relates to an ink jet recording medium suitable for receiving an ink colored with a pigment or dye, thereby recording an image, and a method for making the same.

2. Description of the Related Art

In recent years, various information processing systems have been developed in response to the rapid development of the information industry, and recording methods and apparatuses suitable for the information systems have been also developed and brought into practice.

Among various available recording methods, ink jet recording methods are increasingly being used in the home as well as in business, because such methods are useful in recording on various kinds of recording material, only require relatively low-cost and compact equipment, and are very quiet.

In addition, the recent increases in the resolution of ink jet printers has allowed recording of high quality images with photographic-like quality. With the development of equipment, various kinds of recording media for ink jet recording have been developed. Photographic glossy paper used for recording high quality images with a photographic-like quality is required to have, in addition to the above-described properties, glossiness, surface smoothness, and a texture of photographic paper that is similar to that of a silver salt photo print.

Examples of known ink jet recording sheets which satisfy these requirements include one example composed of a support having thereon a coloring material receiving layer formed by applying a solution containing inorganic fine particles, a mordant, a water-soluble resin such as PVA, and a curing agent for curing the water-soluble resin, and another example composed of a support having thereon a coloring material receiving layer formed by applying a solution composed of inorganic fine particle, a metal compound, and a water-soluble resin such as PVA, and then applying a solution containing a curing agent for curing the water-soluble resin onto the coating before the coating layer is completely dried. In the former example the coloring material receiving layer is formed, for example, by applying a coating solution containing a fumed silica, a cationic polymer (dimethyldiallylammonium chloride polymer), PVA, and boric acid, and then drying the coating. In the latter example, the coloring material receiving layer is formed by applying onto a support a coating solution containing inorganic fine particles such as famed silica having an average primary particle diameter of 20 nm or less, a water-soluble resin such as PVA, and a water-soluble metal salt having a valence of two or more, and concurrently with the application or before the coating layer exhibits a decreasing rate of drying, applying a solution containing a crosslinking agent capable of crosslinking the water-soluble resin (for example, borax or boric acid) thereby curing the coating. The latter example is effective for suppression of cracks. However, both of these examples are unsatisfactory in terms of the printing density and glossiness.

For the purpose of improving the ink absorption properties, an ink jet recording paper disclosed in Japanese Patent Application Laid-Open No. 2001-158167 obtains a high porosity by covalently binding primary particles of a colloidal silica linked in branched or linear chains to an organic compound, thereby offering high absorption properties for deposited ink, and another ink jet recording paper disclosed in JP-A No. 2006-44041 has a multilayer structure, wherein the degree of polymerization of a hydrophilic binder in the upper layer is higher than the degree of polymerization of the hydrophilic binder in the support.

In cases where an image is recorded by ink jet recording using pigment inks, bronzing tends to occur. Pigment inks have been widely used for recording because they are usually superior to dye inks in terms of long-term permanence. Therefore, the establishment of a technique for suppressing the occurrence of bronzing has been regarded as important.

On this account, for example, JP-A Nos. 2002-274013 and 2005-254769 disclose an ink jet recording paper composed of inorganic fine particles, a hydrophilic binder, a compound A containing zirconium atoms or aluminum atoms, and a compound B containing polyvalent metal atoms different from those contained in the compound A, wherein there is a predetermined ratio between the compounds A and B, and there is an ink jet recording material composed of a lower layer and an upper layer, wherein the lower layer comprises a resin binder and inorganic fine particles having an average secondary particle diameter of 500 nm or less, and the upper layer comprises thermoplastic resin particles having a lowest film formation temperature of below 40° C., is applied at a temperature of 40° C. or more and that gives a dry solid content of 0.2 g/m² or less. These materials are expected to have high ink absorption properties and be able to suppress bronzing.

### SUMMARY OF THE INVENTION

The present invention has been made in view of the above circumstances and provides an ink jet recording medium and a method for making the same.

A first aspect of the invention provides an ink jet recording medium comprising a support and at least two layers on one side of the support, wherein the uppermost layer placed farthest from the support comprises a porous colloidal silica and a binder, at least one of the layer(s) that is not the uppermost layer comprises inorganic fine particles having an average primary particle diameter of less than 20 nm and a binder, the content of the inorganic fine particles is 10 g/m² or more, the ratio (A/B) by mass between the inorganic fine particles (A) and the binder (B) is from 3 to 15, and at least the uppermost layer and/or a layer other than the uppermost layer comprises a sulfoxide compound and/or a thioether compound.

A second aspect of the invention provides a method for making an ink jet recording medium comprising applying an intermediate layer coating solution and applying an uppermost layer coating solution onto a support, thereby forming at least an intermediate layer and an uppermost layer successively from the support side, wherein the intermediate layer coating solution comprises inorganic fine particles having an average primary particle diameter of less than 20 nm, a binder and a sulfoxide compound and/or a thioether compound, the content of the inorganic fine particles is 10 g/m² or more, the ratio (A/B) by mass between the inorganic fine particles (A) and the binder (B) is from 3 to 15, and the uppermost layer coating solution comprises a porous colloidal silica and a binder.

### DETAILED DESCRIPTION OF THE INVENTION

With a structure wherein primary particles of a colloidal silica linked in linear or branched chains are covalently bound to an organic compound, the coating solution tends to be destabilized by, for example, the reaction between the colloidal silica and the silane coupling agent. In addition, those ink jet recording papers disclosed in JP-A No. 2006-44041, 2002-274013 and 2005-254769 have poor absorption properties for inks and pigment particles, so that are insufficient to improve the anti-bronzing properties.

The invention present has been accomplished in view of the above-described problems, and is intended to provide an ink jet recording medium and a method for making the same, wherein the ink jet recording medium is able to suppress bronzing caused by pigment inks, allows recording of a high quality image having a high density and glossiness, and provides excellent storability of areas printed with dye inks.

The ink jet recording medium and the method for making the same in accordance with the invention are further described below in detail.

The ink jet recording medium of the invention is intended for recording using pigment inks and/or dye inks, wherein at least two layers are provided on one side of the support, and the uppermost layer of the at least two layers placed farthest from the support comprises a porous colloidal silica and a binder, at least one layer that is not the uppermost layer (hereinafter may be referred to as “intermediate ink receiving layer”) comprises inorganic fine particles having an average primary particle diameter of less than 20 nm and a binder, the content of the inorganic fine particles is 10 g/m² or more, the ratio A/B by mass between the A by mass of the inorganic fine particles and the B by mass of the binder is from 3 to 15, and at least one layer of the uppermost layer and intermediate ink receiving layer provided on the support is composed of a sulfoxide compound and/or a thioether compound.

In the ink jet recording medium of the invention, of the two or more layers provided on the support, the uppermost layer placed farthest from the support is composed of a porous colloidal silica thereby producing a porous structure having relatively large pore diameters corresponding to the particle diameter of the pigment. Therefore, the pigments in the deposited inks penetrate into and are held in the layer within the range of the thickness of the layer without remaining on the layer surface, so that an image having a high density is produced with the occurrence of image bronzing suppressed. When the intermediate ink receiving layer provided between the uppermost layer and the support comprises 10 g/m² or more of inorganic fine particles having an average primary particle diameter of less than 20 nm, and the ratio A/B by mass between the inorganic fine particles and the binder is from 3 to 15, the intermediate ink receiving layer has a porous structure having pore diameters smaller than those of the uppermost layer. Therefore, the pigments in the inks do not penetrate into the intermediate ink receiving layer however are held in, for example, the uppermost layer to contribute the increase of the density, and other components in the inks except for the pigments such as a solvent and components soluble in the solvent penetrate into the intermediate ink receiving layer to offer quick-drying properties. Accordingly, the effect of the ink jet recording medium of the invention is increased when the medium is composed of an unabsorbent support such as a resin-coated support composed of base paper both surfaces of which are laminated with a polyolefin-based resin.

As described above, in accordance with the invention, a high-density and high-quality image may be recorded with the occurrence of bronzing suppressed, wherein the image areas have favorable image clarity with photographic-like glossiness, more specifically, image sharpness measured with an optical comb at a specific frequency.

In the ink jet recording medium of the invention, at least one layer of the two or more layers provided on the support is composed of a sulfoxide compound and/or a thioether compound, and the sulfoxide compound and the thioether compound react with ozone and other components in air instead of dyes, whereby fading of the dyes is remarkably improved. Accordingly, the storability of the printed areas, which is the major weakness of dye inks, is effectively improved.

The above-described image clarity is a scale indicating glossiness. The higher the scale, the higher contribution to glossiness. In the invention, the image clarity may be measured using an image clarity meter ICM-1T (manufactured by Suga Test Instrument Co., Ltd.) having an optical comb (for example, an optical comb of 2.0 mm width) within a specific frequency range, in accordance with the image clarity test method specified in JIS K 7105.

The ink jet recording medium of the invention has two layers or three or more layers on one side of the support, and as necessary, the other side of the support may have, for example, a back layer for the purpose of curling prevention.

<Uppermost Layer>

The pigment inks supplied from the outside are directly deposited on the uppermost layer provided on the support. The uppermost layer comprises at least one kind of porous colloidal silica and at least one kind of binder, and preferably further comprises a sulfoxide compound and/or a thioether compound, and as necessary, may contain other components such as a cationic compound, a compound having a refractive index of 1.5 or more, and an ultraviolet absorber.

### —Porous Colloidal Silica—

In the invention, the porous colloidal silica is a colloidal dispersion of silicon dioxide obtained by double decomposition of sodium silicate with an acid or the like, or high-temperature aging of a silica sol passed through an ion exchange resin layer, and is a synthetic wet process silica having an average primary particle diameter of several nanometers to about 100 nm. The term “porous” means that the silica is composed of chains (beads) structure which is entangled to form gaps to be pores.

Accordingly, in the invention, a chain (beaded) colloidal silica is used from the viewpoint of pigment absorption.

Specific examples of preferable porous colloidal silicas include SNOWTEX PS-SO, PS-MO, PS-S, and PS-M (all manufactured by Nissan Chemical Industries, Ltd.).

In particular, in order to form a pore structure having a pore diameter suitable for penetration of the pigment and to improve glossiness, the colloidal silica is preferably composed of a spherical colloidal silica having an average primary particle diameter of 10 to 50 nm linked together in lengths of 50 to 200 nm. Examples of such spherical colloidal silica include SNOWTEX PS-SO, PS-MO, PS-S, and PS-M.

The colloidal silica may be used in combination of two or more kinds of them. In this case, more preferable combination is a spherical colloidal silica having an average primary particle diameter of 10 nm or more and less than 30 nm and another spherical colloidal silica having an average primary particle diameter of 30 nm or more and 50 nm or less. The ratio of the colloidal silica having an average primary particle diameter of 10 nm or more and less than 30 nm to the total amount of the colloidal silicas is preferably 50% by mass or more.

The porous colloidal silica may be anionic, nonionic, or cationic, and is preferably cationic from the viewpoint of the stability of the coating solution during formation of the layer by application, in particular the stability of the coating solution containing polyvinyl alcohol as a binder, or suppression of aggregation or separation of the colloidal silica with aging of the coating solution. Anionic or nonionic porous colloidal silicas coated with a cationic polymer or the like are also usable because they will not significantly impair the stability of the coating solution.

The content of the porous colloidal silica in the uppermost layer is preferably from 5 to 50 times, more preferably from 10 to 30 times the binder. When the content of the porous colloidal silica is within the range, the pigment is favorably absorbed to produce a high density image, and the occurrence of bronzing is more effectively suppressed.

The uppermost layer may be formed by, for example, applying a coating solution containing a porous colloidal silica and a binder. In this case, for the above-described reason, the content of the porous colloidal silica in the coating solution is preferably from 5 to 50 times, more preferably from 10 to 30 times the binder.

### —Binder—

The binder in the invention is preferably an organic binder, and preferable examples thereof includes various water-soluble polymers and polymer latexes.

Examples of the water-soluble polymer include those based on polyvinyl alcohol, polyethylene glycol, starch, dextrin, carboxymethyl cellulose, polyvinyl pyrrolidone, or polyacrylic ester, and derivatives thereof. Particularly preferable are completely or partially saponified polyvinyl alcohols or cation-modified polyvinyl alcohols.

Among the polyvinyl alcohols, particularly preferable are completely or partially saponified polyvinyl alcohols or cation-modified polyvinyl alcohols having a degree of saponification of 80% or more. The polyvinyl alcohol preferably has an average degree of polymerization of 500 to 5000. Most preferable polyvinyl alcohols are one having a degree of saponification of 95% or more and a degree of polymerization of 1500 to 2000, and another one having a degree of saponification of 88% and a degree of polymerization of 3000 to 4000. Examples of the cation-modified polyvinyl alcohol include polyvinyl alcohols as described in JP-A No. 61-10483, which have primary to tertiary amino groups or a quaternary ammonium group in the main chain or side chain thereof.

The polymer latex is, for example, an acrylic latex, and examples thereof include: acrylic esters or methacrylic esters having an alkyl group, an aryl group, an aralkyl group, or a hydroxyalkyl group; homopolymers or copolymers of acrylonitrile, acrylamide, acrylic acid and methacrylic acid; and copolymers of the monomers with styrenesulfonic acid, vinylsulfonic acid, itaconic acid, maleic acid, fumaric acid, maleic anhydride, vinyl isocyanate, allyl isocyanate, vinyl methyl ether, vinyl acetate, styrene, and divinylbenzene. Another preferable example is an olefin-based latex such as a polymer composed of a vinyl monomer and a diolefin-based copolymer, and examples of the vinyl monomer include styrene, acrylonitrile, methacrylonitrile, methyl acrylate, methyl methacrylate, and vinyl acetate, and examples of the diolefin include butadiene, isoprene, and chloroprene.

The content of the binder in the uppermost layer is preferably 20% by mass or less, more preferably from 3 to 20% by mass, and particularly preferably from 5 to 10% by mass with reference to the porous colloidal silica. When the content of the binder is within the range, scratch resistance is further improved without deterioration in the ink absorption properties.

The uppermost layer may contain, in addition to the binder, a hardener. The hardener hardens the layer by crosslinking the binder (hereinafter referred to as “crosslinking agent”).

Specific examples of the crosslinking agent include: aldehyde-based compounds such as formaldehyde and glutaraldehyde; ketone compounds such as diacetyl and chloropentanedione; compounds having a reactive halogen such as bis(2-chloroethylurea)-2-hydroxy-4,6-dichloro-1,3,5-triazine and those described in U.S. Pat. No. 3,288,775; compounds having a reactive olefin such as divinylsulfone and those described in U.S. Pat. No. 3,635,718; N-methylol compounds as described in U.S. Pat. No. 2,732,316; isocyanates as described in U.S. Pat. No. 3,103,437; aziridine compounds as described in U.S. Pat. Nos. 3,017,280 and 2,983,611; carbodiimide-based compounds as described in U.S. Pat. No. 3,100,704; epoxy compounds as described in U.S. Pat. No. 3,091,537; halogencarboxyaldehydes such as mucochloric acid; dioxane derivatives such as dihydroxydioxane; and inorganic crosslinking agents such as chromium alum, zirconium sulfate, boric acid, and borates. These compounds may be used alone or in combination of two or more kinds of them.

Among them, boric acid or borate is most preferable.

The additive amount of the crosslinking agent is preferably from 0.1 to 40% by mass, and more preferably from 0.5 to 30% by mass with reference to the amount of the binder composing the uppermost layer.

### —Compound Having a Refractive Index of 1.50 or More—

In the invention, the uppermost layer preferably comprises at least one compound having a refractive index of 1.50 or more from the viewpoint of improving glossiness, improving the image density, and suppressing blurring with the lapse of time.

The compound having a refractive index of 1.50 or more is preferably an acidic metal compound, and examples thereof include polyvalent water-soluble metal salt compounds and hydrophobic metal salt compounds. Specific examples thereof include salts or complexes of metals selected from magnesium, aluminum, calcium, scandium, titanium, vanadium, manganese, iron, nickel, zirconium, copper, zinc, gallium, germanium, strontium, yttrium molybdenum, indium, barium, lanthanum, cerium, praseodymium, neodymium, samarium, europium, gadolinium, dysprosium, erbium, ytterbium, hafnium, tungsten, and bismuth.

Specific examples of the above-mentioned metal compound include calcium acetate, calcium chloride, calcium formate, zirconium acetate, zirconium tetrachloride, calcium sulfate, barium acetate, barium sulfate, barium phosphate, manganese chloride, manganese acetate, manganese formate dihydrate, ammonium manganese sulfate hexahydrate, cupric chloride, copper ammonium chloride (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic aluminum polyhydroxide, aluminum sulfite, aluminum thiosulfate, polychlorinated aluminum, aluminum nitrate nonahydrate, aluminum chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, ammonium zinc acetate, zinc ammonium carbonate, titanium tetrachloride, tetraisopropyl titanate, titanium acetylacetonate, titanium lactate, chromium acetate, chromium sulfate, magnesium sulfate, magnesium chloride hexahydrate, magnesium citrate nonahydrate, sodium phosphotungstate, tungsten sodium citrate, 12-tungstophosphoric acid n-hydrate, 12-tungstosilicic acid 26-hydrate, molybdenum chloride, 12-molybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Among them, from the viewpoint of achieving high glossiness, zirconium or aluminum-containing compounds are preferable, and aluminum sulfate, aluminum alum, basic polyaluminum hydroxide, aluminum sulfite, thioaluminum sulfate, polyaluminum chloride, aluminum nitrate nonahydrate, aluminum chloride hexahydrate, zirconium nitrate, and zirconium tetrachloride are more preferable.

As necessary, an alumina pigment such as pseudo-boehmite alumina, alumina hydrate, or fumed alumina is preferably added to provide high glossiness.

The content of the compound having a refractive index of 1.50 or more in the uppermost layer is preferably from 1 to 50% by mass, and more preferably from 2 to 25% by mass with reference to the porous colloidal silica. When the content of the compound having a refractive index of 1.50 or more is within the range, photographic-like high glossiness is provided, whereby an image having more favorable image clarity is produced.

The compound having a refractive index of 1.50 or more may be contained in the uppermost layer and any other layers (intermediate ink receiving layers). From the viewpoint of achieving photographic-like glossiness and improving image clarity, the compound is preferably contained in at least the uppermost layer, and is also preferably contained in both of the uppermost layer and the intermediate ink receiving layer.

### —Sulfoxide Compound, Thioether Compound—

In the invention, at least one compound selected from sulfoxide and thioether compounds is preferably comprised in the uppermost layer only or in the uppermost layer and other layers from the viewpoint of improving the storability of the printed areas (fading caused by trace gas such as ozone and nitrogen oxide in the air).

The thioether compound used in the invention is not specifically limited as long as it comprises a thioether bond such as —S—, —SS—, or —SSS—, and examples of the compound include 3-thia-1,5-heptanediol, 4-thia-1,7-pentanediol, 3,6-dithia-1,8-octanediol, 3,6,9-trithia-1,11-undecanediol, 3,9-dithia-6-oxa-1,11-undecanediol, methylenebis(thioglycollic acid), and bis(2-(2-hydroxyethylthio)ethyl) sulfone. Among these compounds, alkyldiol compounds having 3 to 10 atoms are preferable, and 3,6-dithia-1,8-octanediol is particularly preferable.

Examples of the sulfoxide compound used in the invention include those described in the paragraphs [0026] to [0061] in JP-A No. 2005-7849. The compound is not specifically limited as long as it comprises a bond expressed by the structure (i) shown below. Examples of the compound include the following compounds 1) to 9). Asterisks in the structure (i) and the compound 9) denote combinable hands. The sulfoxide compound preferably has 2 to 10 carbon atoms, and is most preferably methionine sulfoxide.

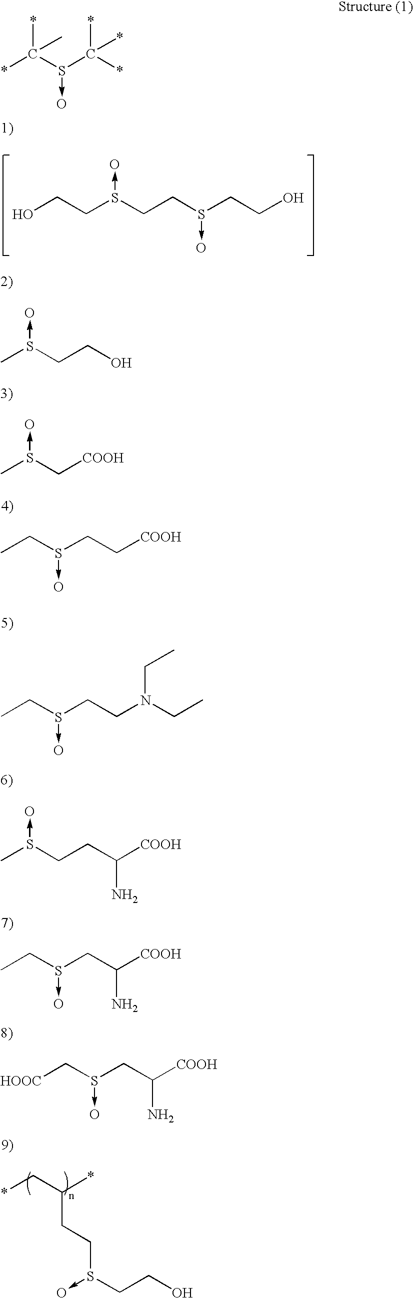

In cases where the uppermost layer comprises a sulfoxide compound and a thioether compound, the total amount of the sulfoxide compound and thioether compound in the uppermost layer is preferably from 0.1 to 10% by mass, and more preferably from 0.5 to 4% by mass with reference to the inorganic fine particles. When the amount of the sulfoxide compound and/or thioether compound is within the range, the storability of the areas printed with dye inks is more effectively improved.

### —Cationic Compound—

In addition to the above mentioned compounds, the uppermost layer in the invention may further contain at least one kind of cationic compound. The cationic compound resides on the surface of colloidal silica and inorganic fine particles to positively charge the particles. The addition of the cationic compound further improves the scratch resistance, water resistance, and ink absorption properties, and prevents aggregation at the interface between the uppermost layer and the lower layer such as an intermediate ink receiving layer to avoid uneven application or uneven glossiness.

The cationic compound is preferably a cationic polymer or a water-soluble polyvalent metal compound. The cationic compound and water-soluble polyvalent metal compound may be used alone or in combination of two or more kinds of them.

Examples of the cationic polymer include water-soluble cationic polymers having a quaternary ammonium group, a phosphonium group, or an acid adduct having primary to tertiary amine. Specific examples thereof include polyethyleneimine, polydialkyldiallylamine, polyallylamine, alkylamine epichlorohydrin polycondensate, and cationic polymers described in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411, and 10-193776.

The weight average molecular weight of the cationic polymer is preferably 100,000 or less, more preferably 50,000 or less, and the lower limit thereof is about 2,000.

The content of the cationic polymer in the uppermost layer is preferably in the range of 1 to 10% by mass with reference to the porous colloidal silica.

### —Solvent—

Preparation of the coating solution for uppermost layer commonly may use a solvent, and the solvent may be water, an organic solvent, or a mixture thereof. Examples of the organic solvent include: alcohols such as methanol, ethanol, n-propanol, i-propanol, and methoxypropanol; ketones such as acetone and methyl ethyl ketone; tetrahydrofuran, acetonitrile, ethyl acetate, and toluene.

### —Other Components—

The uppermost layer may contain other components such as a surfactant, a color dye, a color pigment, an ultraviolet absorber, an antioxidant, a pigment dispersant, an anti-foaming agent, a leveling agent, a preservative, an optical brightener, a viscosity stabilizer, and a pH adjusting agent.

The thickness of the uppermost layer is preferably from 0.05 to 10 μm, and more preferably from 0.1 to 5 μm from the viewpoints of suppression of bronzing and suppression of the decrease of the printing density.

The pore diameter of the uppermost layer is preferably from 0.01 to 0.5 μm, and more preferably from 0.02 to 0.2 μm in terms of median diameter from the viewpoint of pigment absorption from the pigment ink.

The pore diameter (median diameter) may be measured using a mercury porosimeter (trade name: PORESIZER 9320-PC2, manufactured by Shimadzu Corporation).

### <Intermediate Ink Receiving Layer>

In addition to the uppermost layer, a single intermediate ink receiving layer or two or more intermediate ink receiving layers are provided. The intermediate ink receiving layer comprises at least inorganic fine particles having an average primary particle diameter of less than 20 nm and a binder, wherein the content of the inorganic fine particles is 10 g/m² or more and the ratio A/B by mass between the A by mass of the inorganic fine particles and the B by mass of the binder is from 3 to 15. The intermediate ink receiving layer preferably comprises a sulfoxide compound and/or a thioether compound, and as necessary, may further contain other components such as a compound having a refractive index of 1.5 or more, a surfactant, and a dye.

When the intermediate ink receiving layer comprises 10 g/m² or more of relatively small inorganic fine particles having a primary particle diameter of less than 20 nm, and the mass ratio A/B between the inorganic fine particles and the binder is from 3 to 15, the layer has a pore structure having a pore size which does not allow the penetration of the pigment.

In the invention, the content of the inorganic fine particles in the intermediate ink receiving layer is 10 g/m² or more. If the content of the inorganic fine particles is less than 10 g/m², the ink absorption properties are insufficient. The content is preferably 13 g/m² or more, and more preferably 15 g/m² or more from the viewpoint of absorbing the solvent and soluble components in the ink without absorbing the pigment. The upper limit of the content is 50 g/m

### —Inorganic Fine Particles—

The inorganic fine particles in the intermediate ink receiving layer is not particularly limited as to its kind, however are preferably fumed silica, alumina, or an alumina hydrate from the viewpoints of glossiness and ink absorption properties. The addition of the inorganic fine particles allows the formation of a porous structure.

The inorganic fine particles may be used alone or in combination of two or more kinds of them. In the invention, the intermediate ink receiving layer may be composed of a single layer or a plurality of layers. In cases where the intermediate ink receiving layer has a single layer structure, for example, the layer may contain any one kind of or a plurality of kinds of particles selected from fumed silica, alumina, and an alumina hydrate. In cases where the intermediate ink receiving layer is composed of a plurality of layers, for example, the plurality of layers may contain the same kind of or different kinds of particles selected from fumed silica, alumina, and an alumina hydrate. Specific examples of the layer structure include a two-layer structure composed of a fumed silica-containing layer and an alumina- or alumina hydrate-containing layer, and a two-layer structure or a multilayer structure having three or more layers, wherein the layers comprises fumed silica having different particle diameters.

The inorganic fine particles are preferably fumed silica. General silica fine particles are broadly classified into wet process particles and dry process (gas phase process) particles depending on the manufacturing method. Under a gas phase process, anhydrous silica is usually produced by hydrolysis of silicon halide in a high-temperature gas phase (flame hydrolysis process), or by reductively heating silica sand and cokes by arcing in an electric furnace, followed by oxidation with air (arc process). The “fumed silica” refers to fine particles of anhydrous silica produced by a gas phase process. Under the wet process, active silica is formed through acid decomposition of silicate, and then the active silica is polymerized to an appropriate degree to obtain hydrous silica by coagulation sedimentation.

Fumed silica is different from hydrous silica in, for example, the density of the silanol groups on the surface, and the presence or absence of pores, so that they exhibit different properties. Fumed silica is suitable to form a three-dimensional structure having a high porosity. The reason is not evident, however is considered as follows: hydrous silica tends to densely aggregate because it has as much as 5 to 8 silanol groups per square nanometers of the particle surfaces, while fumed silica tends to sparsely flocculate because it has 2 to 3 silanol groups per square nanometers of the particle surfaces, which results in a structure having a high porosity.

Since the fumed silica has a large specific surface area especially, the silica has high ink absorption property and high holding efficiency. Since the silica has low refractive index, the transparency can be imparted to the intermediate ink receiving layer when dispersing to appropriate particle size, and high color density and excellent color can be obtained. It is important that the receiving layer is transparent in view of obtaining high color density and excellent color glossiness even when applying to photographic glossy paper or the like.

Examples of commercially available fumed silica include AEROSIL series manufactured by Nippon Aerosil Co., Ltd. and QS Type manufactured by Tokuyama Corp.

The average primary particle diameter of the fumed silica is preferably less than 20 nm, and from the viewpoints of the ink absorption properties and glossiness, the diameter is more preferably 3 nm or more and less than 20 nm, more preferably 7 nm or more and less than 20 nm, and particularly preferably from 7 to 10 nm. Particles of fumed silica readily adhere to each other via hydrogen bonds between silanol groups. Therefore, fumed silica having an average primary particle diameter less than 20 nm is preferable from the viewpoint of securing the porosity. The fumed silica may provide a high density, effectively improves the ink absorption properties, and increases the transparency and the surface glossiness of the intermediate ink receiving layer.

The fumed silica may be contained in the form of either primary particles or secondary particles.

The primary particle diameters in the present application are nominal values specified by manufacturers of commercial products. The average primary particle diameter of particles in a final recording medium can be measured by scaling the ink receiving layer, treating the layer with hot water to remove the resin component, selectively collecting the particles by centrifugation, and observing the particles with a TEM (transmission electron microscope). In this case, the average primary particle diameter of the particles in the final recording medium can be determined as follows: a reference sample is prepared, for example, in the same manner as the below-described Comparative Example 3, wherein the subbing layer is coated with the ink receiving layer coating solution alone without the use of the colloidal silica layer coating solution, and the reference sample is subjected to the measurement as described above, and the measured value (average) is compared with the known particle diameter of fumed silica particles (nm; 7 nm for Comparative Example 3). From the difference between them, the measured value (average) for the recording medium is determined on a proportional basis. For the measurement of the average primary particle diameter, about 100 to 3,000 particles are necessary.

The fumed silica is preferably used in a dispersed state. The fumed silica can be dispersed by using a cationic resin as a dispersing agent (a cohesion suppressing agent), and can be used as a fumed silica dispersion. The cationic resin is not particularly limited. However, a cationic polymer such as a primary, secondary or tertiary amino group and the salt thereof, and a quaternary ammonium group are preferable, and the examples thereof include the examples of other mordant components described below. A silane coupling agent is also preferably used as a dispersing agent. Water soluble type or water emulsion type or the like can be preferably used. Examples include dicyan based cationic resin such as dicyan diamide-formalin condensation polymer, polyamine based cationic resin such as dicyan amide-diethylene triamine condensation polymer, epichlorhydrin-dimethylamine addition polymer, dimethyl diaryl ammonium chloride-SO₂ copolymer, diaryl amine salt-SO₂ copolymer, dimethyl diaryl ammonium chloridepolymer, polymer of aryl amine salt, dialkyl amino ethyl (meth)acrylate quaternary salt polymer, polycationic based cationic resin such as acryl amide-diaryl amine salt copolymer.

Among them, a fumed silica having a specific surface area of 200 m²/g or more produced by a BET process is particularly preferable. The addition of the fumed silica allows the formation of a porous structure, and improves the absorption properties for the solvent and the like. In addition, when the specific surface area is 200 m²/g or more, the ink absorption properties and quick-drying properties are further improved.

The BET process is a method for measuring the surface area of powder by a vapor phase adsorption method, wherein the total surface area of 1 g of a sample, i.e., the specific surface area is determined from an adsorption isotherm. In usual cases, nitrogen gas is adsorbed, and the adsorbed amount is determined from the variation in the pressure or volume of the adsorbed gas. A most frequently used equation for representing isotherm of polymolecular adsorption is a Brunauer-Emmett-Teller equation (BET equation). The absorbed amount is determined on the basis of the BET equation, and is multiplied by a surface area of one adsorbed molecule to determine the surface area.

The alumina is preferably γ-alumina composed of γ crystals of aluminum oxide, and the crystals are most preferably 6 group crystals. γ-alumina can be minimized to primary particles of about 10 nm, however in usual cases, preferable are those having a diameter of about 50 to 300 nm obtained by pulverizing secondary particle crystals of several thousands to several ten thousands of nanometers using, for example, an ultrasonic or high-pressure homogenizer or a particle collision type jet mill.

The alumina hydrate is expressed by a structural formula of Al₂O₃.nH₂O (n=1 to 3). When n is 1, the alumina hydrate has a boehmite structure, and when n is more than 1 and less than 3, the alumina hydrate has a pseudo-boehmite structure. Alumina hydrate is obtained by a known production process such as hydrolysis of an aluminum alkoxide such as aluminum isopropoxide, neutralization of an aluminum salt with an alkali, or hydrolysis of aluminate.

The average particle diameter of the primary particles of the alumina hydrate is preferably from 5 to 50 nm. In order to achieve higher glossiness, it is preferable to use tabular particles having an average primary particle diameter of 5 to 20 nm and an average aspect ratio (ratio of the average particle diameter to the average thickness) of 2 or more. The average primary particle diameter of the alumina hydrate is a nominal value of specified by the manufacturer of a commercial product. When the diameter is measured from a final recording medium, the same method as used for measuring the average primary particle diameter of the fumed silica may be used.

### —Binder—

The binder in the intermediate ink receiving layer is preferably an organic binder.

The organic binder may be the same as that contained in the uppermost layer. The organic binder is particularly preferably a completely or partially saponified polyvinyl alcohol or cation-modified polyvinyl alcohol. Among the polyvinyl alcohols, particularly preferable is a completely or partially saponified polyvinyl alcohol having a degree of saponification of 80% or more. The average degree of polymerization of the polyvinyl alcohol is preferably from 500 to 5,000.

Examples of the cation-modified polyvinyl alcohol include polyvinyl alcohols as described in JP-A No. 61-10483, which have primary to tertiary amino groups or a quaternary ammonium group in the main chain or side chain thereof.

The intermediate ink receiving layer may contain, in addition to the organic binder, a crosslinking agent. The crosslinking agent may be one of the above-described crosslinking agents. Among the crosslinking agents, boric acid or borates are preferable.

The ratio (A/B) by mass between the A by mass of the inorganic fine particles and the B by mass of the binder is from 3 to 15. If the ratio by mass A/B is less than 3, the ink absorption properties are insufficient, and if more than 15, cracking can occur. From the viewpoint of the ink absorption properties, the ratio is preferably from 4 to 12, and more preferably from 5 to 10.

### —Compound Having a Refractive Index of 1.50 or More—

The intermediate ink receiving layer may contain a compound having a refractive index of 1.50 or more, wherein the compound may be or may be not contained in the uppermost layer. The addition of the compound further improves the glossiness of the recorded surface or the surface of the uppermost layer of the ink jet recording medium.

The details about the compound having a refractive index of 1.50 or more are the same as that contained in the uppermost layer, and preferable exemplary embodiments thereof are also the same.

The content of the compound having a refractive index of 1.50 or more in the intermediate ink receiving layer is preferably from 0.5 to 30% by mass, and more preferably from 1 to 20% by mass with reference to the inorganic fine particles. When the content of the compound having a refractive index of 1.50 or more is within the range, photographic-like high glossiness is provided, whereby an image having more favorable image clarity is produced.

### —Sulfoxide Compound and Thioether Compound—

In order to improve the storability of the printed areas (fading caused by trace gas such as ozone and nitrogen oxide in the air), the intermediate ink receiving layer preferably comprises a sulfoxide compound and a thioether compound, wherein the compound(s) may be or may be not contained in the uppermost layer.

In the invention, in cases where dye inks are used, the dyes in the inks pass through the uppermost layer and are held in the intermediate ink receiving layer. Therefore, from the viewpoint of the storability of the printed areas, the intermediate ink receiving layer (and an uppermost layer) preferably comprises a sulfoxide compound and/or a thioether compound.

The details about the sulfoxide compound and thioether compound are the same as those contained in the uppermost layer, and preferable exemplary embodiments thereof are also the same.

In cases where the intermediate ink receiving layer comprises the sulfoxide compound and thioether compound, the total amount of the sulfoxide compound and thioether compound in the intermediate ink receiving layer is preferably from 0.1 to 10% by mass, and more preferably from 0.5 to 4% by mass with reference to the inorganic fine particles. When the amount of the sulfoxide compound and/or thioether compound is within the range, the storability of the areas printed with dye inks may be effectively improved.

### —Solvent—

The solvent used for the preparation of the intermediate ink receiving layer may be used water, an organic solvent, or a mixed solvent of them. The details about the organic solvent are the same as described above.

### —Other Components—

In addition to the above-described components, the intermediate ink receiving layer may add other various known additives within the range which does not impair the effects of the invention, and examples of the additives include a color dye, a color pigment, a dye fixer, an ultraviolet absorber, an antioxidant, a pigment dispersant, an anti-foaming agent, a leveling agent, a preservative, an optical brightener, a viscosity stabilizer, and a pH adjusting agent.

The thickness of the intermediate ink receiving layer must be enough to absorb all the ink components except for the pigments, and is determined in consideration of the porosity of the layer. For example, when the amount of the ink is 8 nL/mm² and the porosity is 60%, the film must have a thickness of about 15 μm or more. In consideration of this, the thickness of the ink receiving layer is preferably from 10 to 50 μm.

The pore diameter of the ink receiving layer is preferably from 0.005 to 0.030 μm, and more preferably from 0.01 to 0.025 μm in terms of median diameter.

The porosity pore diameter may be measured using a mercury porosimeter (trade name: PORESIZER 9320-PC2, manufactured by Shimadzu Corporation).

Among the above-described ones, from the viewpoints of suppressing the occurrence of bronzing and producing a high-density and high-gloss image, the ink jet recording medium of the invention is particularly preferably composed of an uppermost layer and an intermediate ink receiving layer, wherein the uppermost layer comprises a porous colloidal silica, polyvinyl alcohol (PVA), boric acid or borate, and a compound having a refractive index of 1.7 or more containing zirconium or aluminum (particularly polyaluminum hydroxide), the porous colloidal silica is SNOWTEX PS-SO, the intermediate ink receiving layer comprises a fumed silica having an average primary particle diameter of 0.01 μm or less, PVA, and boric acid or borate, the content of the fumed silica is from 13 to 20 g/m², and the mass ratio A/B between the fumed silica and PVA is from 3 to 10.

### <Support>

The support is preferably a water-resistant support such as: a plastic resin film composed of a polyester resin such as polyethylene terephthalate, a diacetate resin, a triacetate resin, an acrylic resin, a polycarbonate resin, polyvinyl chloride, a polyimide resin, cellophane, or celluloid; a laminate of paper and a resin film; and a polyolefin resin-coated paper composed of paper at least one side of which is bonded to a hydrophobic resin such as a polyolefin resin.

The thickness of the water-resistant support is from 50 to 300 μm, and preferably from 80 to 260 μm.

The support composed of polyolefin resin-coated paper (hereinafter referred to as polyolefin resin-coated paper) which is preferably used in the invention is further described below in detail.

The moisture content of the polyolefin resin-coated paper is not particularly limited, however is preferably from 5.0 to 9.0%, and more preferably from 6.0 to 9.0% from the viewpoint of the curling properties. The moisture content of the polyolefin resin-coated paper may be measured using any moisture measurement method such as one using an infrared aquameter, an over drying method, a dielectric constant method, or a Karl Fischer method.

The base paper composing the polyolefin resin-coated paper is not particularly limited, and may be commonly used paper. More preferable is smooth base paper used as, for example, a support for photographs. The base paper is composed of one or more kinds of pulp such as natural pulp, regenerated pulp, and synthetic pulp. The base paper comprises additives which are commonly used for papermaking, such as a sizing agent, a paper strengthening agent, a filler, an anti-static agent, an optical brightener, and a dye.

The surface of the base paper may be coated with, for example, a surface sizing agent, a surface paper strengthening agent, an optical brightener, an anti-static agent, a dye, and an anchoring agent.

The base paper is not particularly limited as to its thickness, however the surface thereof is preferably smoothened by compression through calendering or the like during or after paper making, and preferably has a basis weight of 30 to 250 g/m².

The polyolefin resin for coating the base paper is a homopolymer of an olefin such as low-density polyethylene, high-density polyethylene, polypropylene, polybutene, or polypentene; a copolymer composed of two or more olefins such as an ethylene-propylene copolymer; or a mixture of these polymers. These polymers having different densities and melting viscosity indexes (melt index) may be used alone or in combination with each other.

The resin of the polyolefin resin-coated paper preferably comprises an appropriate combination of various additives such as: a white pigment such as titanium oxide, zinc oxide, talc, or calcium carbonate; a fatty acid amide such as stearic acid amide, or arachic acid amide; a fatty acid metal salt such as zinc stearate, calcium stearate, aluminum stearate, or magnesium stearate; an antioxidant such as IRGANOX 1010 or IRGANOX 1076; a blue pigment or dye such as cobalt blue, ultramarine blue, cerulean blue, or phthalocyanine blue; a magenta pigment or dye such as cobalt violet, fast violet, or manganese violet; an optical brightener; and an ultraviolet absorber.

The polyolefin resin-coated paper is usually produced by a so-called extrusion coating method, wherein a heat-melted polyolefin resin is flow-cast on running base paper, and at least one side of the base paper is coated with the resin. Before coating of the base paper with the resin, the base paper is preferably subjected to any activation treatment such as corona discharge treatment or flame treatment. From the viewpoint of the ink absorption properties, one side of the base paper on which the ink receiving layer is to be provided (the front side of the base paper) is preferably not coated with the resin. However, as described above, the invention has a multilayer structure composed of at least two layers containing the uppermost layer and the intermediate ink receiving layer, so that it is also preferable that the resin be applied onto the side on which the ink receiving layer is to be provided. The opposite side (the back side of the base paper) preferably has a resin layer from the viewpoint of curling prevention. The back side is usually unglossy. The back side alone, or as necessary both of the front and back sides may be subjected to any activation treatment such as corona discharge treatment or flame treatment.

In the invention, a resin-coated support composed of base paper the both sides of which are laminated with a polyolefin-based resin is preferable.

The thickness of the resin-coated layer is not particularly limited. In usual cases, one side or both of the front and back sides are coated with the resin in a thickness of 5 to 50 μm. In cases where only one side is coated with the resin, the thickness of the polyolefin resin-coated layer is preferably from about 5 to 25 μm from the viewpoint of the curling properties of the resulting ink jet recording material.

The one side of the polyolefin resin-coated paper on which the ink receiving layer is to be provided (hereinafter referred to as “front side of the polyolefin resin-coated paper”) has a resin layer, wherein, from the viewpoints of glossiness and smoothness, the resin layer is preferably formed by heat-melting a polyolefin resin by an extruder, extruding the melt between the base paper and a cooling roll into the form of a film, and compressing and cooling the film. The cooling roll is used to form the surface shape of the polyolefin resin-coated layer, and the front side of the resin layer may be embossed according to the surface shape of the cooling roll thereby producing a mirror finished surface, a micro-rough surface, or a patterned surface such as a tweed or matte surface.

The other side of the polyolefin resin-coated paper on which no ink receiving layer is to be provided (hereinafter referred to as “back side of the polyolefin resin-coated paper”) may be an uncoated base paper when the front side is coated with the resin, however from the viewpoints of improving the curling properties and the printed image, the back side preferably has a resin layer which is formed generally by heat-melting a polyolefin resin by an extruder, extruding the melt between the base paper and a cooling roll into the form of a film, and compressing and cooling the film. From the viewpoints of the transferability in a printer and the printed image, the cooling roll is preferably capable of embossing according to the surface shape of the cooling roll surface thereby producing a micro-rough surface or a patterned surface such as a tweed or matte surface having an Ra of 0.8 to 5 μm in accordance with JIS-B-0601.

Examples of the method for providing the polyolefin resin-coated layer on the back side and the front side of the base paper include extrusion of a heat-melt resin, application of an electron radiation curable resin followed by irradiation with electron beams, and application of a coating solution containing a polyolefin resin emulsion followed by drying and surface smoothing. In each case, a polyolefin resin-coated paper adaptable to the invention is produced after embossing with a heat roll or the like having a patterned indented surface.

A subbing layer may be formed on the surface of the polyolefin resin-coated paper. The subbing layer has been applied to and dried on the surface of the water-resistant support before the ink receiving layer is formed.

The subbing layer is composed mainly of a water-soluble polymer or a polymer latex which can be formed into a film. The polymer is preferably a water-soluble polymer such as gelatin, polyvinyl alcohol, polyvinylpyrrolidone, or water-soluble cellulose, and is particularly preferably gelatin. The mass of deposit of the water-soluble polymer is preferably from 10 to 500 mg/m², and is more preferably from 20 to 300 mg/m².

The subbing layer preferably further contain a surfactant and a crosslinking agent. The base paper is preferably subjected to corona discharge before the application of the subbing layer.

The ink jet recording medium of the invention is produced by coating the support with a preparation for forming an intermediate ink receiving layer and a preparation for forming an uppermost layer in this order by means of application or other method, wherein the uppermost layer is placed on the ink receiving layer on the side not opposed to the support.

The ink jet recording medium of the invention is more preferably produced by the below-described method of the invention for producing an ink jet recording medium for pigment ink.

More specifically, the method contain application of a coating solution for forming an intermediate layer (hereinafter referred to as “intermediate ink receiving layer coating solution”) and an uppermost layer coating solution onto a support by independent application or simultaneous multilayer application, whereby a layer other than the uppermost layer (intermediate ink receiving layer) and the uppermost layer are formed on the one side of the support in this order, wherein the intermediate ink receiving layer coating solution comprises inorganic fine particles having an average primary particle diameter less than 20 nm, a binder, and a sulfoxide compound and/or a thioether compound, the content of the inorganic fine particles is 10 g/m² or more, the ratio (A/B) by mass between the inorganic fine particles (A) and the binder (B) is from 3 to 15, and the uppermost layer coating solution comprises a porous colloidal silica and a binder. In this case, the uppermost layer coating solution may further contain a sulfoxide compound and/or a thioether compound to produce an ink jet recording medium exhibiting more excellent storability of printed areas.

The support is preferably a resin-coated support composed of base paper the both sides of which are coated with a polyolefin-based resin, and the details about the support are the same as described above.

The application may be carried out by a known application method using, for example, an extrusion die coater, an air doctor coater, a blade coater, a rod coater, a knife coater, a squeeze coater, a reverse roll coater, or a bar coater.

In the invention, the intermediate ink receiving layer coating solution and the uppermost layer coating solution are preferably applied by simultaneous multilayer application. The simultaneous multilayer application may be carried out by, for example, an application method using an extrusion die coater or a curtain flow coater. After the simultaneous application, the formed coating layer is dried.

In cases where the simultaneous multilayer application is carried out using, for example, an extrusion die coater, the two kinds of coating solutions simultaneously ejected are formed into double layers near the ejecting port of the extrusion die coater, more specifically before being transferred onto the support, and applied onto the support in the form of the double layers. If the ejected two liquids may be readily mixed near the ejecting port of the extrusion die coater to hinder the application operation, a barrier layer coating solution (intermediate layer coating solution) intervening between the two solutions may be applied concurrently with them to carry out simultaneous three-layer application.

No limitation is imposed on the selection of the barrier layer coating solution. Examples of the coating solution include water and an aqueous solution containing a small amount of water-soluble resin. The water-soluble resin is used for thickening and other purposes, in consideration of the coating properties. Examples of the water-soluble resin include polymers such as a cellulose-based resin (for example, hydroxypropyl methyl cellulose, methyl cellulose, or hydroxyethyl methyl cellulose), polyvinyl pyrrolidone, and gelatin. The barrier layer coating solution may contain a mordant.

The intermediate ink receiving layer may be formed by, for example, applying an intermediate ink receiving layer coating solution containing at least a fumed silica, a binder, and a sulfoxide compound and/or a thioether compound onto the support surface, and then crosslinking the coating layer by adding a basic solution having a pH of 7.1 or more at either of the following points: (1) concurrent with the formation of the coating layer by the application; or (2) during drying of the coating layer formed by the application and before the coating layer exhibits a decreasing rate of drying. The crosslinking agent for crosslinking the binder may be contained in the intermediate ink receiving layer coating solution and the basic solution. In this case, after the formation of the intermediate ink receiving layer, the uppermost layer coating solution is applied onto the intermediate ink receiving layer, and then dried to form a multilayer structure. The pH of the basic solution is preferably 7.5 or more, and particularly preferably 7.9 or more from the viewpoint of suppressing the occurrence of bronzing and cracking.

The basic solution may contain a crosslinking agent and a mordant component as necessary. The point “before the coating layer exhibits a decreasing rate of drying” usually refers to the interval of several minutes from immediately after the application of the intermediate ink receiving layer coating solution.

All this while, the content of the solvent (dispersion medium) in the coating layer decreases proportional to the time, exhibiting a “constant rate of drying”. The interval showing the “constant rate of drying” is described in, for example, Kagaku Kogaku Binran (p. 707 to 712, issued by Maruzen Co. Ltd., Oct. 25, 1980).

In the method for producing the ink jet recording medium of the invention, the application step is preferably followed by a drying step, wherein at least the surface of the uppermost layer formed by the application step is subjected to alkali treatment with a basic gas to dry at least the uppermost layer. The alkali treatment of the coating layer with a basic gas increases the pH of the layer surface, whereby the crosslinking reaction of the binder by the crosslinking agent progresses only on the surface to gelate the surface only, which is considered to result in high glossiness.

Drying through alkali treatment with a basic gas may be carried out for drying the uppermost layer, in addition, for drying the intermediate ink receiving layer, wherein the surface of the intermediate ink receiving layer is subjected to alkali treatment with a basic gas. In this case, the intermediate ink receiving layer coating solution further comprises a crosslinking agent for crosslinking the binder.

A specific example of the method for drying the uppermost layer comprises steps of stirring a mixture of a porous colloidal silica, polyvinyl alcohol (PVA; binder), boric acid, a cationic polymer, and a surfactant to prepare an uppermost layer coating solution, applying the coating solution, and then drying the coating layer.

A specific example of the method for drying the intermediate ink receiving layer comprises steps of preparing an intermediate ink receiving layer solution as described below from a fumed silica, polyvinyl alcohol (PVA), a sulfoxide compound and/or a thioether compound, boric acid, a cationic resin, a nonionic or ampholytic surfactant, and a high boiling point organic solvent, applying the coating solution, and then drying the coating layer. More specifically, the intermediate ink receiving layer coating solution is prepared as follows: a fumed silica is added to water, a cationic resin is further added to the mixture and dispersed with, for example, a high pressure homogenizer or a sand mill, and boric acid is added to the dispersion. Subsequently, a PVA aqueous solution is added to the mixture so as to the amount of PVA is about ⅓ the fumed silica in terms of mass, to which a nonionic or ampholytic surfactant and a high boiling point organic solvent are added and stirred to obtain the coating solution. The obtained coating solution is a uniform sol, and is applied by any of the following methods to provide a coating layer on the support thereby forming a porous ink receiving layer having a three-dimensional network structure. The addition of boric acid to PVA after being diluted as described above prevents partial gelation of PVA.

Aqueous dispersion having an average particle size of 10 to 300 nm can be prepared by grain-refining the coating liquid for the ink receiving layer using a disperser. Known various dispersers such as a high speed rotating disperser, a medium stirring type disperser (a ball mill, a sand mill or the like), an ultrasonic disperser, a colloid mill disperser, and a high pressure disperser can be used as a disperser which is used for obtaining the aqueous dispersion. However, the medium stirring type disperser, the colloid mill disperser and the high pressure disperser are preferable in view of dispersing efficiently agglomerate-like fine particles formed.

In the drying step, the coating layer is dried by, for example, drying at a temperature of 30 to 150° C. (preferably 50 to 120° C.) for 5 to 30 minutes (preferably from 10 to 20 minutes). The drying time varies depending on the coating weight, however usually within the above-described range. Examples of drying means include a hot air drier and infrared ray irradiation.

In the drying step, the coating layer is subjected to alkali treatment with a basic gas. The alkali treatment means exposure of the coating layer surface to a basic gas, whereby crosslinking reaction between the water-soluble resin and a crosslinking agent proceeds only near the surface to gelate the surface only. Examples of convenient basic gas used for the alkali treatment include water-soluble amines such as ammonia gas, dimethylamine, trimethylamine, and pyridine.

The concentration of the basic gas for the alkali treatment is preferably 3 ppm or more, and more preferably 6 ppm or more. The upper limit is not particularly limited, however usually about 30 ppm.

Through the control of the concentration of the basic gas, glossiness can be freely varied. More specifically, glossiness increase as the increase in the concentration of the basic gas, and glossiness decreases as the decrease in the concentration. The concentration of the basic gas used for the alkali treatment refers to the concentration in a demarcated space used in the drying step, or the concentration in the drying zone.

The alkali treatment is preferably carried out when the solid content concentration of the coating layer is 20% by mass or less, or during the coating layer of the intermediate ink receiving layer coating solution exhibits a constant rate of drying (before it exhibits a decreasing rate of drying) from the viewpoint of selectively gelating the layer surface to achieve high glossiness.

The interval “during coating layer exhibits a constant rate of drying” refers to that before the coating layer exhibits a decreasing rate of drying.

### EXAMPLES

The invention is further illustrated with reference to the following examples, however the invention is not limited to the examples without departing from the scope of the invention. Unless otherwise noted, “part” and “%” are based on the mass.

### Example 1

### Preparation of Polyolefin Resin-Coated Paper

A 1:1 mixture of hardwood bleached kraft pulp (LBKP) and hardwood bleached sulfite pulp (LBSP) was beaten to a Canadian Standard freeness of 300 ml thereby preparing a pulp slurry. To the slurry, an alkyl ketene dimer as a sizing agent, polyacrylamide as a strengthening agent, cationized starch, and a polyamide epichlorohydrin resin were added at a ratio of 0.5%, 1.0%, 2.0%, and 0.5%, respectively, and the mixture was diluted with water to make a 1% slurry. The slurry was processed through a fourdrinier machine into a sheet having a basis weight of 170 g/m², and the sheet was dried and conditioned to give a base paper.

Anatase titanium was uniformly dispersed in a low-density polyethylene resin having a density of 0.918 g/cm³ at a ratio of 10% to 100% to make a polyethylene resin composition, and the composition was melted at a temperature of 320° C., and applied onto one side of the base paper by extrusion at the rate of 200 m/minute in a thickness of 35 μm, and then extrusion coating was carried out using a cooling roll having a micro-rough surface. Subsequently, a blend resin composition composed of 70 parts of a high-density polyethylene resin having a density of 0.962 g/cm³ and 30 parts of a low-density polyethylene resin having a density of 0.918 was melted at a temperature of 320° C. in the same manner, and applied onto the other side by extrusion in a thickness of 30 μm, and then extrusion coating was carried out using a cooling roll having a rough surface.

As described above, a polyolefin resin-coated paper was obtained.

The surface of the polyolefin resin-coated paper was subjected to high frequency corona discharge treatment, and then the following composition was applied onto the surface and dried to form a subbing layer containing 50 mg/m² of gelatin, and the paper was used as a support.

### <Subbing Layer Composition>

| | | |
|---|---|---|
| Lime-processed gelatin | 100 | parts |
| Sulfosuccinic acid-2-ethylhexyl ester salt | 2 | parts |
| Chromium alum | 10 | parts |

In order to form an ink receiving layer (intermediate ink receiving layer) and a colloidal silica layer (uppermost layer) on the support of the subbing layer in this order, an ink receiving layer coating solution and a colloidal silica layer coating solution A having the following compositions were simultaneously applied in double layers using a slide bead coater, and dried to make an inkjet recording sheet for pigment ink in accordance with the invention.

The ink receiving layer coating solution was prepared so as to contain 9% fumed silica, wherein the pH of the coating solution was 4.0, and the ratio between the inorganic fine particles (A) to the binder (B) was 4.54. The wet coating weight of the ink receiving layer coating solution was 200 g/m², and the solid coating weight of the below-described fumed silica was 18 g/m².

The colloidal silica layer coating solution A was prepared so as to the concentration of the colloidal silica was 0.4 g/m² in terms of the solid content. The wet coating weight of the colloidal silica layer coating solution A was 5 g/m², and the solid content coating weight of the colloidal silica was 1 g/m².

### <Ink Receiving Layer Coating Solution Composition>

| | | |
|---|---|---|
| AEROSIL 300 (fumed silica manufactured by Nippon | 100 | parts |
| Aerosil Co., Ltd., average primary particle | | |
| diameter: 7 nm, specific surface area | | |
| measured by BET: 300 m²/g) | | |
| SHAROLL DC902P (dimethyldiallyl ammonium chloride | 4 | parts |
| homopolymer manufactured by Dai-Ichi Kogyo | | |
| Seiyaku Co., Ltd., molecular weight: 9000) | | |
| Boric acid (crosslinking agent) | 3 | parts |
| Polyvinyl alcohol (PVA; binder) (degree of | 22 | parts |
| saponification: 88%, average degree of | | |
| polymerization: 3500) | | |
| 3,6-dithia-1,8-octanediol (thioether compound) | 3 | parts |
| Basic polyaluminum hydroxide (trade name: | 3 | parts |
| PURACHEM WT, manufactured by Riken Green Co., | | |
| Ltd.; compound having a refractive index of | | |
| 1.5 or more) | | |
| SWANOL AM (betaine-based surfactant manufactured | 0.3 | part |
| by Nihon Surfactant Kogyo K.K.) | | |

<Colloidal Silica Layer Coating Solution a Composition>

| | | |
|---|---|---|
| SNOWTEX PS-SO (spherical anionic colloidal silica | 100 | parts |
| manufactured by Nissan Chemical Industries, Ltd., | | |
| average primary particle diameter: 10 to 15 nm, | | |
| average secondary particle diameter: 80 to 120 nm) | | |
| POLYFIX 700 (special modified polyamine manufactured | 1 | part |
| by Showa Highpolymer Co., Ltd., cationic polymer) | | |
| PVA117 (binder) (degree of saponification: 98.5%, | 4 | parts |
| average degree of polymerization: 1700) | | |
| SWANOL AM (betaine-based surfactant manufactured | 0.3 | part |
| by Nihon Surfactant Kogyo K.K.) | | |
| Boric acid (crosslinking agent) | 0.1 | part |

### Example 2

The ink jet recording medium of the invention was prepared in the same manner as Example 1, except that 3 parts of 3,6-dithia-1,8-octanediol (thioether compound) were replaced with 3 parts of methionine sulfoxide (sulfoxide compound).

### Example 3

The ink jet recording medium of the invention was prepared in the same manner as Example 1, except that SNOWTEX PS-SO in the colloidal silica layer coating solution A was replaced with SNOWTEX PS-SO (anionic spherical colloidal silica manufactured by Nissan Chemical Industries, Ltd., average primary particle diameter: 18 to 25 nm, average secondary particle diameter: 80 to 150 nm).

### Example 4

The ink jet recording medium of the invention was prepared in the same manner as Example 1, except that 10 parts of Zircozol ZA-30 (zirconium acetate manufactured by Daiichi Kigenso Kagaku Kogyo Co., Ltd.) were added to the ink receiving layer coating solution, and 1.8 parts of the Zircosol ZA-30 (zirconium acetate) were added to the colloidal silica layer coating solution A.

### Example 5

The ink jet recording medium of the invention was prepared in the same manner as Example 1, except that the amount of PURACHEM WT (basic polyaluminum hydroxide manufactured by Riken Green Co., Ltd.) was changed from 3 parts to 6 parts, and 0.9 parts of the PURACHEM WT (basic polyaluminum hydroxide) were further added to the colloidal silica layer coating solution A.

### Example 6

The ink jet recording sheet of the invention was prepared in the same manner as Example 1, except that after the simultaneous multilayer application was followed by drying with air containing 10 ppm of ammonia concentration.

### Example 7

The ink jet recording sheet of the invention was prepared in the same manner as Example 1, except that 0.9 parts of basic polyaluminum hydroxide were added to the colloidal silica layer coating solution A.

### Example 8

The ink jet recording sheet of the invention was prepared in the same manner as Example 1, except that AEROSIL 300 in the ink receiving layer coating solution was replaced with AEROSIL 200 (average primary particle diameter: 12 nm, specific surface area measured by BET: 200 m²/g, manufactured by Nippon Aerosil Co., Ltd.).

### Example 9

The ink jet recording sheet of the invention was prepared in the same manner as Example 1, except that the ratio (A/B) between AEROSIL 300 (inorganic fine particles) and PVA (binder) in the ink receiving layer coating solution was adjusted to 10.

### Example 10

The ink jet recording sheet of the invention was prepared in the same manner as Example 1, except that the coating weight of AEROSIL 300 (inorganic fine particles) was changed from 18 g/m² to 12 g/m², wherein the ratio A/B was 4.54.

### Comparative Example 1

A comparative ink jet recording medium was prepared in the same manner as Example 1, except that SNOWTEX PS-SO in the colloidal silica layer coating solution A was replaced with SNOWTEX OL (manufactured by Nissan Chemical Industries, Ltd., average primary particle diameter: 40 to 50 nm).

### Comparative Example 2

A comparative ink jet recording medium was prepared in the same manner as Example 1, except that SNOWTEX PS-SO in the colloidal silica layer coating solution A was replaced with SNOWTEX O (manufactured by Nissan Chemical Industries, Ltd., average primary particle diameter: 10 to 20 nm).

### Comparative Example 3

A comparative ink jet recording medium was prepared in the same manner as Example 1, except that the ink receiving layer coating solution was applied alone onto the subbing layer with no application of the colloidal silica layer coating solution A.

### Comparative Example 4

A comparative ink jet recording medium was prepared in the same manner as Example 1, except that AEROSIL 300 in the ink receiving layer coating solution was replaced with AEROSIL 90G (average primary particle diameter: 20 nm, specific surface area measured by BET: 90 m²/g, manufactured by Nippon Aerosil Co., Ltd.).

### Comparative Example 5

A comparative ink jet recording medium was prepared in the same manner as Example 1, except that AEROSIL 300 in the ink receiving layer coating solution was replaced with AEROSIL 50 (average primary particle diameter: 30 nm, specific surface area measured by BET: 50 m²/g, manufactured by Nippon Aerosil Co., Ltd.).

### Comparative Example 6

A comparative ink jet recording medium was prepared in the same manner as Example 1, except that AEROSIL 300 in the ink receiving layer coating solution was replaced with AEROSIL OX50 (average primary particle diameter: 40 nm, specific surface area measured by BET: 50 m²/g, manufactured by Nippon Aerosil Co., Ltd.).

### Comparative Example 7

A comparative ink jet recording sheet was prepared in the same manner as Example 1, except that the ratio (A/B) between AEROSIL 300 (inorganic fine particles) and PVA (binder) in the ink receiving layer coating solution was adjusted to 2.

### Comparative Example 8

A comparative ink jet recording sheet was prepared in the same manner as Example 1, except that the ratio (A/B) between AEROSIL 300 (inorganic fine particles) and PVA (binder) in the ink receiving layer coating solution was adjusted to 20.

### Comparative Example 9

A comparative ink jet recording sheet was prepared in the same manner as Example 1, except that the solid coating weight of AEROSIL 300 (inorganic fine particles) was changed from 18 g/m² to 5 g/m².

### Comparative Example 10

A comparative ink jet recording sheet was prepared in the same manner as Example 1, except that the thioether compound was not contained in the ink receiving layer coating solution.

### (Evaluation)

The ink jet recording sheets of the invention and comparative ink jet recording sheets obtained as described above were subjected to the following evaluations. The evaluation results are summarized in Tables 1 and 2.

### —1. Bronzing—

A solid cyan image was printed on each of the ink jet recording sheets using an ink jet printer (trade name: PX-G930, manufactured by Seiko Epson Corporation), and stored for one day at a temperature of 23° C. and a relative humidity of 50%. Thereafter, the condition of the printed image was visually observed, and the occurrence of bronzing was evaluated on the basis of the following criteria.

<Evaluation Criteria>

A: No bronzing occurred.

B: Slight and allowable bronzing occurred.

C: Partial and practically allowable bronzing occurred.

D: Significant bronzing occurred.

### —2. 60° Glossiness—

A solid black image was printed on each of the ink jet recording sheets using an ink jet printer (trade name: PX-G930, manufactured by Seiko Epson Corporation). Thereafter, the glossiness of the solid image areas was measured at an incidence angle of 60° and an acceptance angle of 60° using a digital variable angle glossmeter UGV-5D (measuring hole: 8 mm, manufactured by Suga Test Instrument Co., Ltd.).

### —3. Image Clarity—

A solid cyan image was printed on each of the ink jet recording sheets using an ink jet printer (trade name: PX-G930, manufactured by Seiko Epson Corporation) to form sample images for measurement. The solid image areas and unprinted areas on the ink jet recording sheets were measured for the image clarity C (%) using an image clarity meter ICM-1T (manufactured by Suga Test Instrument Co., Ltd.) under the following measurement conditions and analysis conditions in accordance with the image clarity test method defined in JIS K7105. The measurement was carried out in the main scanning direction and sub-scanning direction during printing. Subsequently, the image clarity C was determined for each optical comb in accordance with the following formula a.

Image clarity C(%)={(M−m)/(M+m)}×100 Formula a

### <Measurement Conditions and Analysis Conditions>

Measurement method: Reflection

Measuring angle: 60°

Optical comb width: 2.0 mm

### —4. Storability of Printed Areas—

An image of cyan color, which is the most susceptible to fading, was printed using a dye ink printer (trade name: PM-970C, manufactured by Seiko Epson Corporation) so as to give an optical density of 1.0, and the image was exposed to air at room temperature for three months. Thereafter, the optical density of the printed areas was measured, and the residual rate (optical density after exposure/optical density before exposure) was determined, and used as the index for evaluating the storability of the printed areas.

TABLE 1

| | Uppermost | Ink receiving layer | | | | Evaluation | | | | | | |
|---|---|---|---|---|---|---|---|---|---|---|---|---|
| | layer | Inorganic fine | | Silica | | | 60° glossiness | | Image clarity | | | |
| | Inorganic | particles/ | | coating | | | | Solid | | Solid | Black | Storability |
| | fine | particle | | weight | | | Unprinted | image | Unprinted | image | image | of printed |
| | particles | diameter | A/B | (g/m²) | Drying | Bronzing | areas | areas | areas | areas | density | areas |
| Example | PS-SO | AEROSIL | 4.54 | 18 | — | B | 55 | 100 | 140 | 122 | 2.10 | 95 |
| 1 | (*1) | 300/(7 nm) | | | | | | | | | | |
| Example | PS-SO | AEROSIL | 4.54 | 18 | — | B | 55 | 100 | 140 | 122 | 2.11 | 96 |
| 2 | (*1) | 300/(7 nm) | | | | | | | | | | |
| Example | PS-MO | AEROSIL | 4.54 | 18 | — | A | 52 | 102 | 135 | 130 | 2.06 | 95 |
| 3 | (*1) | 300/(7 nm) | | | | | | | | | | |
| Example | PS-SO | AEROSIL | 4.54 | 18 | — | B | 60 | 95 | 140 | 120 | 2.11 | 95 |
| 4 | (*1) | 300/(7 nm) | | | | | | | | | | |
| Example | PS-SO | AEROSIL | 4.54 | 18 | — | B | 62 | 95 | 138 | 120 | 2.12 | 95 |
| 5 | (*1) | 300/(7 nm) | | | | | | | | | | |
| Example | PS-SO | AEROSIL | 4.54 | 18 | Ammonia | B | 65 | 95 | 130 | 125 | 2.12 | 95 |
| 6 | (*1) | 300/(7 nm) | | | | | | | | | | |
| Example | PS-SO | AEROSIL | 4.54 | 18 | Ammonia | B | 70 | 105 | 140 | 120 | 2.11 | 95 |
| 7 | (*1) | 300/(7 nm) | | | | | | | | | | |
| Example | PS-SO | AEROSIL200/ | 4.54 | 18 | — | B | 54 | 98 | 141 | 125 | 2.10 | 95 |
| 8 | (*1) | (12 nm) | | | | | | | | | | |

| | Uppermost | Ink receiving layer | | | | | | | | | | |
|---|---|---|---|---|---|---|---|---|---|---|---|---|
| | layer | Inorganic fine | | Silica | | Evaluation | | | | | | |
| | Inorganic | particles/ | | coating | | | | | | | Black | Storability |
| | fine | particle | | weight | | | | | | | image | of printed |
| | particles | diameter | A/B | (g/m²) | Drying | Bronzing | 60° glossiness | | Image clarity | | density | areas |
| Example | PS-SO | AEROSIL | 10 | 18 | — | B | 55 | 102 | 140 | 123 | 2.15 | 95 |
| 9 | (*1) | 300/(7 nm) | | | | | | | | | | |
| Example | PS-SO | AEROSIL | 4.54 | 12 | — | B | 55 | 101 | 139 | 125 | 2.07 | 95 |
| 10 | (*1) | 300/(7 nm) | | | | | | | | | | |

(*1): PS-SO is SNOWTEX PS-SO manufactured by Nissan Chemical Industries, Ltd.
PS-MO is SNOWTEX PS-MO manufactured by Nissan Chemical Industries, Ltd.
PS-OL is SNOWTEX PS-OL manufactured by Nissan Chemical Industries, Ltd.
PS-O is SNOWTEX O manufactured by Nissan Chemical Industries, Ltd.

TABLE 2

| | Uppermost | Ink receiving layer | | | | Evaluation | | | | | | |
|---|---|---|---|---|---|---|---|---|---|---|---|---|
| | layer | Inorganic fine | | Silica | | | 60° glossiness | | Image clarity | | | |
| | Inorganic | particles/ | | coating | | | | Solid | | Solid | Black | Storability |
| | fine | particle | | weight | | | Unprinted | image | Unprinted | image | image | of printed |
| | particles | diameter | A/B | (g/m²) | Drying | Bronzing | areas | areas | areas | areas | density | areas |
| Comparative | OL | AEROSIL | 4.54 | 18 | — | D | 61 | 90 | 142 | 75 | 2.11 | 95 |
| Example 1 | (*1) | 300/(7 nm) | | | | | | | | | | |
| Comparative | — | AEROSIL | 4.54 | 18 | — | D | 65 | 95 | 150 | 70 | 2.12 | 95 |
| Example 2 | | 300/(7 nm) | | | | | | | | | | |
| Comparative | PS-SO | AEROSIL | 4.54 | 18 | — | D | 21 | 70 | 170 | 80 | 2.13 | 95 |
| Example 3 | (*1) | 300/(7 nm) | | | | | | | | | | |
| Comparative | PS-SO | AEROSIL | 4.54 | 18 | — | A | 54 | 100 | 142 | 130 | 1.95 | 95 |
| Example 4 | (*1) | 90G/(20 nm) | | | | | | | | | | |
| Comparative | PS-SO | AEROSIL | 4.54 | 18 | — | A | 50 | 90 | 130 | 130 | 1.70 | 98 |
| Example 5 | (*1) | 50/(30 nm) | | | | | | | | | | |
| Comparative | PS-SO | AEROSIL | 4.54 | 18 | — | A | 48 | 85 | 140 | 130 | 1.60 | 98 |
| Example 6 | (*1) | OX50/(40 nm) | | | | | | | | | | |
| Comparative | PS-SO | AEROSIL | 2 | 18 | — | Ink | 48 | 85 | 140 | Ink | Ink | |
| Example 7 | (*1) | 300/(7 nm) | | | | bleeding | | | | bleeding | bleeding | |
| Comparative | PS-SO | AEROSIL | 20 | 18 | — | Unevaluated because of cracking | | | | | | |
| Example 8 | (*1) | 200/(12 nm) | | | | | | | | | | |
| Comparative | PS-SO | AEROSIL | 4.54 | 5 | — | Ink | 46 | 88 | 145 | Ink | Ink | |
| Example 9 | (*1) | 300/(7 nm) | | | | bleeding | | | | bleeding | bleeding | |
| Comparative | PS-SO | AEROSIL | 4.54 | 18 | — | B | 55 | 100 | 140 | 122 | 2.1 | 70 |
| Example 10 | (*1) | 300/(7 nm) | | | | | | | | | | |

(*1): PS-SO is SNOWTEX PS-SO manufactured by Nissan Chemical Industries, Ltd.
PS-MO is SNOWTEX PS-MO manufactured by Nissan Chemical Industries, Ltd.
PS-OL is SNOWTEX PS-OL manufactured by Nissan Chemical Industries, Ltd.
PS-O is SNOWTEX PS-O manufactured by Nissan Chemical Industries, Ltd.

As shown in Tables 1 and 2, the ink jet recording sheets of Examples exhibited good resistance to bronzing and good image clarity of the solid image areas with pigment inks, and provided a high image density. In addition, the sheets provided good storability of the printed areas with dye inks. As shown by Examples 6 and 7, glossiness was effectively improved by drying the coatings in an ammonia-containing atmosphere.

On the other hand, bronzing was not suppressed with SNOWTEX OL or O (Comparative Examples 1 to 2), or a single layer structure having no upper layer containing the porous colloidal silica (Comparative Example 3). Even when the upper layer containing the porous colloidal silica was provided to improve bronzing, a high image density was not achieved when the average primary particle diameter of the silica particles in the lower layer was 20 nm or more (Comparative Examples 4 to 6). When the ratio between the silica particles and the binder in the ink receiving layer was outside the range of 3 to 15 (Comparative Examples 7 and 8), the ink absorption properties were poor, or cracking occurred after drying. Even when the ratio between the silica particles and the binder was within the above-described range, the ink absorption properties were still poor when the amount of the silica particles was small (Comparative Example 9). When no thioether compound was used (Comparative Example 10), the areas printed with dye inks showed poor storability, and apparent fading occurred.

In accordance with the invention, an ink jet recording medium and a method for making the same were provided, the ink jet recording medium suppressing the occurrence of bronzing with pigment inks, capable of recording of a high quality image having a high density and high glossiness, and achieving excellent storability of the areas printed with dye inks.

The invention also includes the following embodiments.

<1> An ink jet recording medium comprising a support and at least two layers on one side of the support, wherein the uppermost layer placed farthest from the support comprises a porous colloidal silica and a binder, at least one of the layer(s) that is not the uppermost layer comprises inorganic fine particles having an average primary particle diameter of less than 20 nm and a binder, the content of the inorganic fine particles is 10 g/m² or more, the ratio (A/B) by mass between the inorganic fine particles (A) and the binder (B) is from 3 to 15, and at least the uppermost layer and/or a layer other than the uppermost layer comprises a sulfoxide compound and/or a thioether compound.

<2> The ink jet recording medium of item <1>, wherein at least the uppermost layer and/or a layer other than the uppermost layer further comprises a compound having a refractive index of 1.50 or more.

<3> The ink jet recording medium of item <2>, wherein the compound having a refractive index of 1.50 or more is a metal compound.

<4> The ink jet recording medium of any one of items <1> to <3>, wherein the porous colloidal silica comprises a spherical colloidal silica having an average primary particle diameter of 10 to 50 nm, the spherical colloidal silica being linked together in lengths of 50 to 200 nm.

<5> The ink jet recording medium of any one of items <2> to <4>, wherein at least one of the compound(s) having a refractive index of 1.50 or more comprises zirconium or aluminum.

<6> The ink jet recording medium of any one of items <1> to <5>, wherein the support is a resin-coated support composed of base paper both surfaces of the base paper being coated with a polyolefin-based resin.

<7> A method for making an ink jet recording medium comprising applying an intermediate layer coating solution and applying an uppermost layer coating solution onto a support, thereby forming at least an intermediate layer and an uppermost layer successively from the support side, wherein the intermediate layer coating solution comprises inorganic fine particles having an average primary particle diameter of less than 20 nm, a binder and a sulfoxide compound and/or a thioether compound, the content of the inorganic fine particles is 10 g/m² or more, the ratio (A/B) by mass between the inorganic fine particles (A) and the binder (B) is from 3 to 15, and the uppermost layer coating solution comprises a porous colloidal silica and a binder.

<8> The method for making an ink jet recording medium of item <7>, wherein the support is a resin-coated support composed of base paper both surfaces of the base paper being coated with a polyolefin-based resin.

<9> The method for making an ink jet recording medium of items <7> or <8>, wherein at least the uppermost layer coating solution further comprises a crosslinking agent for crosslinking the binder, and the method further comprises drying the uppermost layer through alkali treatment of at least the surface of the uppermost layer with a basic gas.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. An ink jet recording medium comprising a support and at least two layers on one side of the support, wherein the uppermost layer placed farthest from the support comprises a porous colloidal silica and a binder, at least one of the layer(s) that is not the uppermost layer comprises inorganic fine particles having an average primary particle diameter of less than 20 nm and a binder, the content of the inorganic fine particles is 10 g/m² or more, the ratio (A/B) by mass between the inorganic fine particles (A) and the binder (B) is from 3 to 15, and at least the uppermost layer and/or a layer other than the uppermost layer comprises a sulfoxide compound and/or a thioether compound.

2. The ink jet recording medium of claim 1, wherein at least the uppermost layer and/or a layer other than the uppermost layer further comprises a compound having a refractive index of 1.50 or more.

3. The ink jet recording medium of claim 2, wherein the compound having a refractive index of 1.50 or more is a metal compound.

4. The ink jet recording medium of claim 1, wherein the porous colloidal silica comprises a spherical colloidal silica having an average primary particle diameter of 10 to 50 nm, the spherical colloidal silica being linked together in lengths of 50 to 200 nm.

5. The ink jet recording medium of claim 2, wherein the porous colloidal silica comprises a spherical colloidal silica having an average primary particle diameter of 10 to 50 nm, the spherical colloidal silica being linked together in lengths of 50 to 200 nm.

6. The ink jet recording medium of claim 3, wherein the porous colloidal silica comprises a spherical colloidal silica having an average primary particle diameter of 10 to 50 nm, the spherical colloidal silica being linked together in lengths of 50 to 200 nm.

7. The ink jet recording medium of claim 2, wherein at least one of the compound(s) having a refractive index of 1.50 or more comprises zirconium or aluminum.

8. The ink jet recording medium of claim 1, wherein the support is a resin-coated support composed of a base paper, both surfaces of the base paper being coated with a polyolefin-based resin.

9. The ink jet recording medium of claim 2, wherein the support is a resin-coated support composed of a base paper, both surfaces of the base paper being coated with a polyolefin-based resin.

10. The ink jet recording medium of claim 4, wherein the support is a resin-coated support composed of a base paper, both surfaces of the base paper being coated with a polyolefin-based resin.

11. A method for making an ink jet recording medium comprising applying an intermediate layer coating solution and applying an uppermost layer coating solution onto a support, thereby forming at least an intermediate layer and an uppermost layer successively from the support side, wherein the intermediate layer coating solution comprises inorganic fine particles having an average primary particle diameter of less than 20 nm, a binder and a sulfoxide compound and/or a thioether compound, the content of the inorganic fine particles is 10 g/m² or more, the ratio (A/B) by mass between the inorganic fine particles (A) and the binder (B) is from 3 to 15, and the uppermost layer coating solution comprises a porous colloidal silica and a binder.

12. The method for making an ink jet recording medium of claim 11, wherein the support is a resin-coated support composed of a base paper, both surfaces of the base paper being coated with a polyolefin-based resin.

13. The method for making an ink jet recording medium of claim 11, wherein at least the uppermost layer coating solution further comprises a crosslinking agent for crosslinking the binder, and the method further comprises drying the uppermost layer through alkali treatment of at least the surface of the uppermost layer with a basic gas.

14. The method of for making an ink jet recording medium claim 12, wherein at least the uppermost layer coating solution further comprises a crosslinking agent for crosslinking the binder, and the method further comprises drying the uppermost layer through alkali treatment of at least the surface of the uppermost layer with a basic gas.
